(19) United States
(12) Patent Application Publication
(10) Pub. No.: US 2025/0121476 A1
(43) Pub. Date: Apr. 17, 2025

(54) CLAMPING MECHANISM AND CLAMPING APPARATUS

(71) Applicants: Luzhou Laojiao Co., Ltd., Luzhou (CN); Luzhou Laojiao Niangjiu Co., Ltd., Luzhou (CN); Qingzhou Pengcheng Packaging Machinery Co., Ltd., Weifang (CN)

(72) Inventors: Junwu LIN, Luzhou (CN); Feng YU, Luzhou (CN); Tao HU, Luzhou (CN); Hongtao FU, Luzhou (CN); Ziji LIN, Luzhou (CN); Xin LIU, Luzhou (CN); Chuanpeng HAO, Luzhou (CN)

(73) Assignees: Luzhou Laojiao Co., Ltd., Luzhou (CN); Luzhou Laojiao Niangjiu Co., Ltd., Luzhou (CN); Qingzhou Pengcheng Packaging Machinery Co., Ltd., Weifang (CN)

(21) Appl. No.: 18/913,169

(22) Filed: Oct. 11, 2024

(30) Foreign Application Priority Data
Oct. 13, 2023 (CN) 2023113303247

(51) Int. Cl. B25B 5/06

(52) U.S. Cl. CPC B25B 5/06

(57) ABSTRACT

The present invention relates to the technical field of clamping equipment and discloses a clamping mechanism and a clamping apparatus. In the present invention, by connecting the first actuating end of the first drive motor to the first connecting member in a motion-transmission manner, connecting the plurality of plate members to the first connecting member, and rotating the first actuating end in the horizontal plane, it is realized that, when the first actuating end rotates, it can drive the first connecting member to rotate in the horizontal plane, and a limiting member is provided, the limiting member is spaced apart from the first connecting member and is configured to rotate in unison with the first connecting member, so that, during the rotation of the first connecting member, each of the plate members is driven to move towards or away from a neighboring plate member by means of translational movement, thereby changing the spacing between the plurality of plate members that are spaced apart from one another and arranged underneath the first connecting member, so as to clamp or loosen the products. As compared to the way of use of a single clamping mechanism or multiple clamping mechanisms in the prior art, the present application uses a clamping mechanism that can simultaneously clamp or loosen multiple products, so as to improve the efficiency of the product transporting or placing, thereby saving time and reducing production costs.

### TECHNICAL FIELD

The present invention relates to the technical field of clamping equipment, and specifically relates to a clamping mechanism and a clamping apparatus.

### BACKGROUND

As the automation industry becomes more and more perfect, a variety of automated equipments tend to replace manual work, realizing transformation from manual work to automatic production, however, the industrial requirements for automated equipment is also becoming higher and higher, not only to consider the production process, but also to consider the cost reduction and quality enhancement, especially in the wine industry, basically it is still in the stage of manual work or semi-mechanized operation, with high production costs and low degree of automation.

In conventional technology, in order to increase the degree of automation, it is often necessary to use a clamping mechanism to clamp multiple products to complete the transporting or placement of multiple products. For example, when using multiple robotic arms, each robotic arm grips a product to complete the transporting or placing of multiple products, which leads to high production costs; therefore, a single robotic arm is often used to grip one product at a time, which completes the transporting or placing of multiple products after performing multiple times of gripping. However, the use of a single robotic arm requires downtime for maintenance in the event of a robotic arm malfunction, and the normal transporting or placing of products is less efficient due to the need to work multiple times.

### SUMMARY OF THE INVENTION

In view of this, the present invention provides a clamping mechanism and a clamping apparatus to solve the problem of low efficiency when transporting or placing products with an existing clamping mechanism.

In a first aspect, the present invention provides a clamping mechanism comprising a first drive assembly and a clamping assembly, the first drive assembly comprising a first frame and a first drive motor, the first drive motor being provided with a first fixed end and a first actuating end, the first fixed end being mounted on the first frame, and the first actuating end being rotatable in a horizontal plane; the clamping assembly comprising a first connecting member and a plurality of plate members, the first connecting member being connected to the first actuating end in a motion-transmission manner, the plurality of plate members being all connected to the first connecting member, each of the plate members being mounted underneath the first connecting member along a height direction, and the plurality of plate members being spaced apart from one another; wherein a limiting member is also provided between every two adjacent plate members, the limiting member is spaced apart from the first connecting member and is configured to rotate in unison with the first connecting member, and under the action of the first drive motor, the first actuating end drives the first connecting member to rotate, so as to drive each of the plate members to move towards or away from a neighboring plate member by means of translational movement.

Beneficial effect: by connecting the first actuating end of the first drive motor to the first connecting member in a motion-transmission manner, connecting the plurality of plate members to the first connecting member, and rotating the first actuating end in the horizontal plane, it is realized that, when the first actuating end rotates, it can drive the first connecting member to rotate in the horizontal plane, and a limiting member is also provided, the limiting member is spaced apart from the first connecting member and is configured to rotate in unison with the first connecting member, so that, during the rotation of the first connecting member, each of the plate members is driven to move towards or away from a neighboring plate member by means of translational movement, thereby changing the spacing between the plurality of plate members that are spaced apart from one another and arranged underneath the first connecting member, so as to clamp or loosen the products. As compared to the way of use of a single clamping mechanism or multiple clamping mechanisms in the prior art, the present application uses a clamping mechanism that can simultaneously clamp or loosen multiple products, so as to improve the efficiency of the product transporting or placing, thereby saving time and reducing production costs.

In an optional embodiment, the clamping assembly further comprises a second connecting member and a fastener, wherein the second connecting member passes through the first connecting member and is rotatably connected to the first connecting member; each plate member is connected to the second connecting member by means of the fastener.

In an optional embodiment, the plate members include a first plate member and a second plate member, the first plate member being movably connected to the first actuating end, wherein, there are two second plate members, the two second plate members are respectively arranged on two lateral sides of the first plate member along a horizontal direction and are respectively located at two ends of the first connecting member.

Beneficial effect: by providing two second plate members, the two second plate members can simultaneously clamp two sets of products side by side in cooperation with the first plate member, thereby further improving the efficiency of the product transporting or placing.

In an optional embodiment, the first connecting member is provided with a rotation portion; the clamping assembly further comprises a motion-transmission member, an inner wall of the motion-transmission member is form-fitted to the first actuating end and is sleeved on an exterior of the first actuating end, an outer wall of the motion-transmission member passes through the rotation portion of the first connecting member and is connected to an inner wall of the rotation portion in a position-limiting manner; wherein, under the action of the first drive motor, the first actuating end drives the motion-transmission member to rotate, and the motion-transmission member drives the first connecting member to rotate, so as to drive each of the plate members to move towards a neighboring plate member.

In an optional embodiment, each of the plate members extends along a first direction; there are a plurality of first connecting members, the plurality of first connecting members being spaced apart from one another along the first direction, the motion-transmission member being mounted at the rotation portion of one of the first connecting members, wherein each of the remaining first connecting members has a rotation portion rotatably connected to the first frame and constitutes the limiting member.

Beneficial effect: by providing the plurality of first connecting members spaced apart from one another along the first direction, mounting the motion-transmission member connected to the first actuating end at the rotation portion of one of the first connecting members, and rotatably connecting the rotation portion of each of the remaining first connecting members to the first frame, so that, during the rotation of one of the connecting members driven by the first actuating end, that is, during the change of spacing between each of the plate members and its neighboring plate member, due to that the plurality of first connecting members are all connected to the plate members, the plate members can drive the remaining first connecting members to rotate in unison, so that, when the plurality of products are being simultaneously clamped, each product is clamped to a similar or even uniform degree, so that the ability of the clamping mechanism for clamping products is more reliable.

In an optional embodiment, the clamping mechanism further comprises: a second drive assembly, comprising a second drive motor, a second frame and a transmission structure, the second drive motor being provided with a second fixed end and a second actuating end, the second fixed end being fixedly mounted on an external bracket, the second frame being mounted upon the first frame, the transmission structure comprising a rack and a gear, the rack being fixedly connected to the second frame, an extending direction of the rack being parallel to a vertical direction, the gear being connected to the second actuating end in a motion-transmission manner, and the gear being connected to the rack in a motion-transmission manner.

Beneficial effect: by providing the second drive assembly, connecting the second actuating end of the second drive motor to the gear in a motion-transmission manner, and mounting the second frame upon the first frame, at this time, if the second fixed end of the second drive motor is fixedly connected on an external bracket, due to that the extending direction of the rack is parallel to a vertical direction, the gear can drive the rack to move along the vertical direction under the action of the second actuating end, and thus realizing that the second frame fixedly connected to the rack can move along the vertical direction, realizing that the first frame connected to the second frame can move along the vertical direction, and thus realizing that the plate members can move along the vertical direction, so that the clamping mechanism has the ability to move the clamped products along the vertical direction, which improves the experience of the user when using the clamping mechanism.

In an optional embodiment, the second drive assembly further comprises a first connecting shaft, a second connecting shaft, a mounting base and a seated bearing, one end of the first connecting shaft being connected to the second actuating end by means of a first coupling in a motion-transmission manner; one end of the second connecting shaft being connected to the other end of the first connecting shaft by means of a second coupling in a motion-transmission manner, the other end of the second connecting shaft being connected to the gear in a motion-transmission manner; the mounting base being mounted on the second frame; the seated bearing comprising a bearing seat and a bearing inner ring, the bearing seat being mounted on the mounting base, and the bearing inner ring being sleeved on the second connecting shaft.

In an optional embodiment, the second drive assembly further comprises a sliding block and a sliding rail, the sliding block being mounted on the mounting base, the sliding rail being mounted on the second frame, the sliding rail being movably connected to the sliding block, the sliding rail being oriented in the vertical direction.

Beneficial effect: by providing the sliding block and the sliding rail, it is realized that the sliding block can be moved along the guiding direction of the slide rail after the sliding block is mounted on the mounting base, which can reduce the resistance encountered by the clamping mechanism when it is moved along the vertical direction.

In an optional embodiment, there are two second actuating ends; the first connecting shaft is arranged in one-to-one correspondence with the two second actuating ends; the second connecting shaft is arranged in one-to-one correspondence with the two second actuating ends; the mounting base is arranged in one-to-one correspondence with the two second actuating ends; the seated bearing is arranged in one-to-one correspondence with the two second actuating ends; the transmission structure is arranged in one-to-one correspondence with the two second actuating ends.

In a second aspect, the present invention also provides a clamping apparatus comprising the clamping mechanism as described above.

Since the clamping apparatus adopts the clamping mechanism of the present application, it has the same beneficial effects as those of the clamping mechanism, which will not be repeated herein.

### BRIEF DESCRIPTION OF THE DRAWINGS

In order to more clearly explain the technical solutions in specific implementations of the present invention or in the prior art, accompanying drawings that need to be used in the description of the specific implementations or the prior art are briefly introduced below. Apparently, the accompanying drawings described below only represent some implementations of the present invention. For a person with ordinary skill in the art, other drawings are obtainable according to these accompanying drawings without expenditure of any creative labor.

FIG. 1 is a structural schematic diagram of a clamping mechanism of an embodiment of the present invention;

FIG. 2 is a front view of a clamping mechanism of an embodiment of the present invention;

FIG. 3 is a partially enlarged schematic diagram of part K in FIG. 2;

FIG. 4 is a partially enlarged schematic diagram of part M in FIG. 2;

FIG. 5 is a cross-sectional schematic diagram of the A-A section in FIG. 2;

FIG. 6 is a cross-sectional schematic diagram of the B-B section in FIG. 2;

FIG. 7 is a cross-sectional schematic diagram of the C-C section in FIG. 2;

FIG. 8 is a top view of a clamping mechanism of an embodiment of the present invention.

### DESCRIPTION OF REFERENCE SIGNS

1—first drive assembly; 11—first frame; 12—first drive motor; 121—first fixed end; 122—first actuating end;
2—clamping assembly; 21—first connecting member; 22—second connecting member; 23—fastener; 24—first plate member; 25—second plate member; 26—motion-transmission member;
3—second drive assembly; 31—second drive motor; 311—second fixed end; 312—second actuating end; 32—second frame; 33—transmission structure; 331—gear; 332—rack; 34—first connecting shaft; 351—first coupling; 352—second coupling; 36—second connecting shaft; 37—seated bearing; 371—bearing seat; 372—bearing inner ring; 38—sliding block; 39—sliding rail; 41—mounting base.

### DETAILED DESCRIPTION

In order to make the objectives, technical solutions and advantages of the embodiments of the present invention clearer, hereinafter, the technical solution in the embodiments of the present invention will be clearly and completely described in combination with accompanying drawings in the embodiments of the invention. Apparently, embodiments described represent part of the embodiments of the present invention, not all the embodiments. All other embodiments obtainable by those skilled in the art based on the embodiments described in the present invention without expenditure of creative labor all fall within the scope of protection of the present invention.

In the related technology, in order to realize the unloading and extraction of multiple stored products by using a clamping mechanism, for example, when the clamping mechanism is a robotic arm, multiple robotic arms are usually used to each clamp a product separately, which leads to high production costs, therefore, a single robotic arm is often used to grip one product at a time and perform multiple times of gripping, so as to complete the transporting or placing of multiple products. However, this leads to low efficiency in transporting or placing of products, which is not conducive to saving time and reducing production costs.

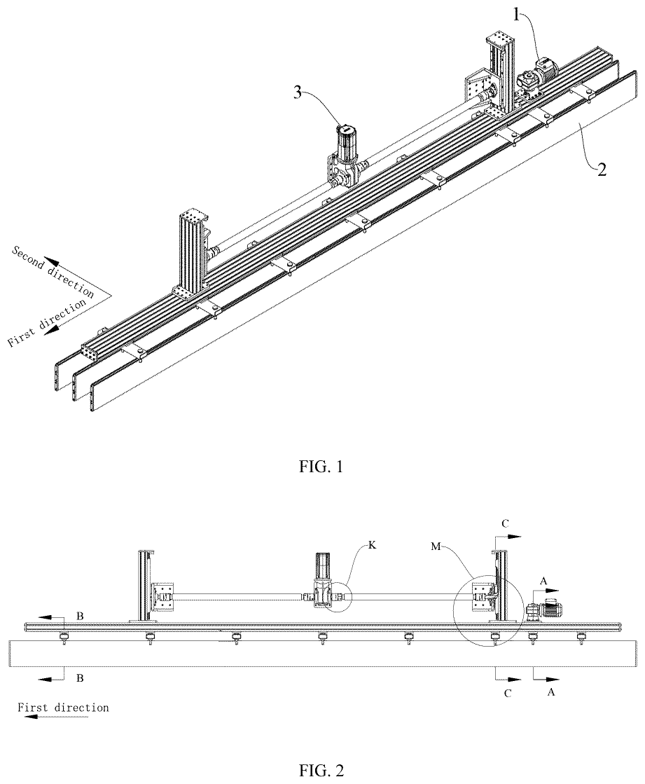

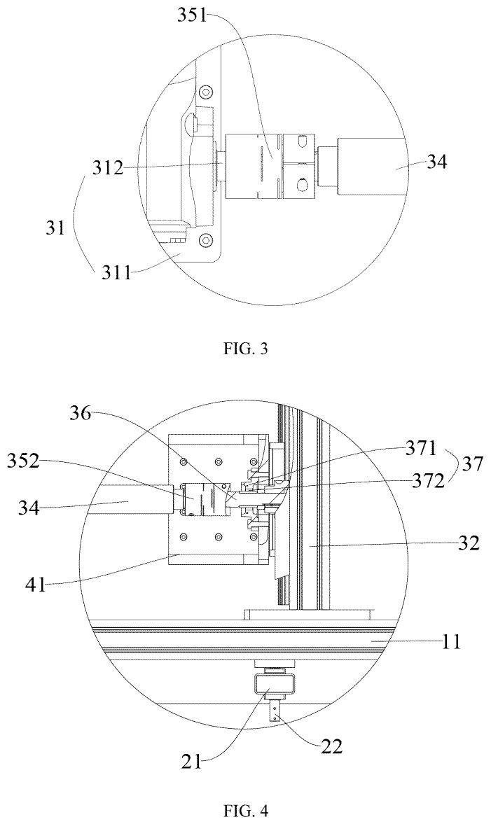

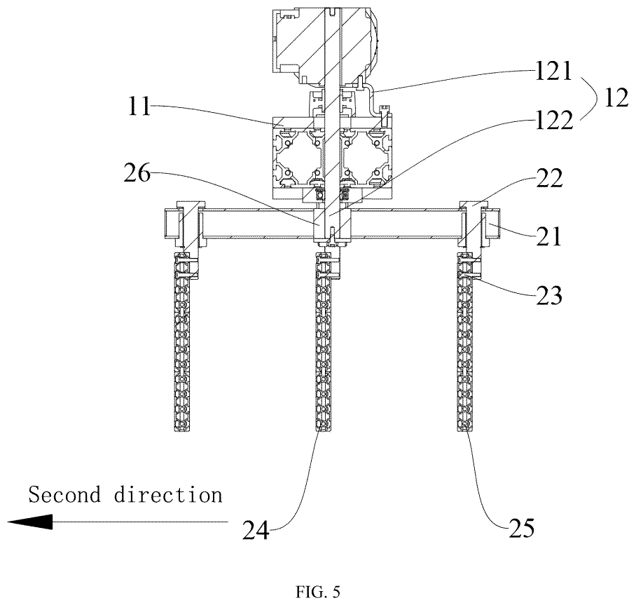

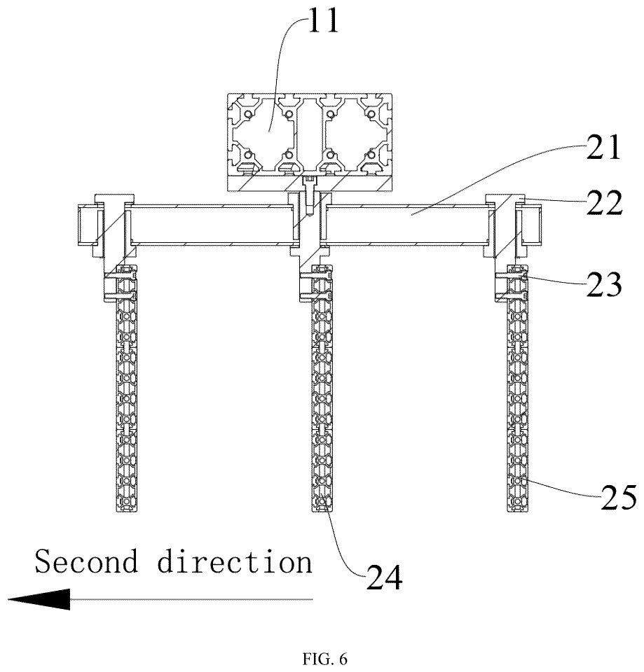

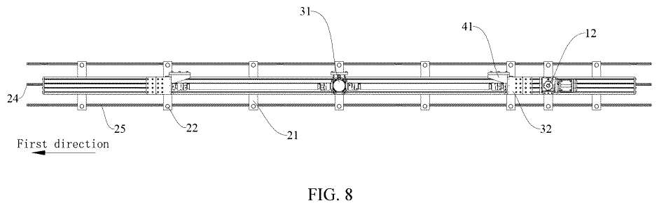

Embodiments of the present invention are described below in combination with FIGS. 1 to 8.

According to an embodiment of the present invention, in a first aspect, a clamping mechanism is provided, and as shown in FIGS. 1 to 8, the clamping mechanism of this structure comprises a first drive assembly 1 and a clamping assembly 2, wherein the first drive assembly 1 comprises a first frame 11 and a first drive motor 12, the first drive motor 12 is provided with a first fixed end 121 and a first actuating end 122, the first fixed end 121 is mounted on the first frame 11, and the first actuating end 122 is rotatable in a horizontal plane; the clamping assembly 2 comprises a first connecting member 21 and a plurality of plate members, the first connecting member 21 is connected to the first actuating end 122 in a motion-transmission manner, the plurality of plate members are all connected to the first connecting member 21, each of the plate members is mounted underneath the first connecting member 21 along a height direction, and the plurality of plate members are spaced apart from one another; wherein a limiting member is also provided between every two adjacent plate members, the limiting member is spaced apart from the first connecting member 21 and is configured to rotate in unison with the first connecting member 21, and under the action of the first drive motor 12, the first actuating end 122 drives the first connecting member 21 to rotate, so as to drive each of the plate members to move towards or away from a neighboring plate member by means of translational movement.

Specifically, the clamping mechanism provided in this embodiment is not specifically limited by the products to be clamped. The product mentioned in this embodiment may be any one of a bottle cap, a bottle body, or a packaging box, in accordance with the actual situation of the wine industry production.

In this embodiment, the first frame 11 is made of profiled piece(s), such as connecting a plurality of aluminum profiled pieces to form the first frame 11, so as to reduce the weight of the first frame 11, and thus reduce the weight of the entire clamping mechanism, so as to make the clamping mechanism lighter when it moves under the action of external forces.

With the above-described structure of the clamping mechanism, by connecting the first actuating end 122 of the first drive motor 12 to the first connecting member 21 in a motion-transmission manner, connecting the plurality of plate members to the first connecting member 21, and rotating the first actuating end 122 in the horizontal plane, it is realized that, when the first actuating end 122 rotates, it can drive the first connecting member 21 to rotate in the horizontal plane, and a limiting member is also provided, the limiting member is spaced apart from the first connecting member 21 and is configured to rotate in unison with the first connecting member 21, so that, during the rotation of the first connecting member 21, each of the plate members is driven to move towards or away from a neighboring plate member by means of translational movement, thereby changing the spacing between the plurality of plate members that are spaced apart from one another and arranged underneath the first connecting member 21, so as to clamp or loosen the products. As compared to the way of use of a single clamping mechanism or multiple clamping mechanisms in the prior art, the present application uses a clamping mechanism that can simultaneously clamp or loosen multiple products, so as to improve the efficiency of the product transporting or placing, thereby saving time and reducing production costs.

In one embodiment, the clamping assembly 2 further comprises a second connecting member 22 and a fastener 23, wherein the second connecting member 22 passes through the first connecting member 21; each plate member is connected to the second connecting member 22 by means of the fastener 23 and is thereby rotatably connected to the first connecting member 21.

Specifically, the fastener 23 in this embodiment adopts a bolt, by which each plate member is fixedly connected to the second connecting member 22, facilitating the removal of the plate members during subsequent maintenance of the clamping mechanism.

In one embodiment, the plate members include a first plate member 24 and a second plate member 25, the first plate member 24 being movably connected to the first actuating end 122, wherein, there are two second plate members 25, the two second plate members 25 are respectively arranged on two lateral sides of the first plate member 24 along a horizontal direction and are respectively located at two ends of the first connecting member 21.

With this structure of the clamping mechanism, by providing two second plate members 25 and making the two second plate members 25 simultaneously clamp two sets of products side by side in cooperation with the first plate member 24, the efficiency of the product transporting or placing is further improved.

Specifically, in this embodiment, the first plate member 24 and the second plate member 25 have the same structure, at this time, the first plate member 24 is centrally arranged underneath the first connecting member 21, and the two second plate members 25 are symmetrically arranged on two lateral sides of the first plate member 24. Of course, in other embodiments, the two second plate members 25 and the first plate member 24 are not equally spaced apart from each other, and it is also sufficient to realize clamping of the products.

Further, in other embodiments, if there is a need to further improve the efficiency of transporting or placing multiple products, one first plate member 24 and two second plate members 25 can be grouped to be a set of plate members, and a plurality of sets of plate members are provided underneath the first connecting member 21, so that multiple rows of products can be simultaneously transported, thereby improving the efficiency of product transporting.

Specifically, in this embodiment, if there is a need to simultaneously transport or place any product selected from multiple size types, or if there is a need to simultaneously transport multiple types of products, the respective positions of the plate members relative to their neighboring plate members can be adjusted respectively, i.e., one or more selected from the first plate member 24 and the second plate members 25 can be adjusted.

Further, in this embodiment, the position at which the second plate member 25 is mounted on the first connection member 21 can be adjusted. As one implementation way, the first connecting member 21 is provided with a plurality of mounting holes equally distributed along a second direction, and after adjusting the second connecting member 22 to be mounted into one of the mounting holes at different positions, the second connecting member 22 is connected to the second plate member 25 by means of the fastener 23, thereby realizing the adjustment of the spacing between the second plate member 25 and the first plate member 24. As another implementation way, the first connecting member 21 is provided with a waist-shaped hole, at this time, by adjusting the position of the second connecting member 22 within the waist-shaped hole, and then connecting the second connecting member 22 to the second plate member 25 by means of the fastener 23, the adjustment of the spacing between the second plate member 25 and the first plate member 24 can also be realized.

Further, in other embodiments, the position of the first plate member 24 can also be adjusted.

It is noted that, in the above embodiments, the second direction is perpendicular to the first direction within a horizontal plane.

In one embodiment, the first connecting member 21 is provided with a rotation portion; the clamping assembly 2 further comprises a motion-transmission member 26, an inner wall of the motion-transmission member 26 is form-fitted to the first actuating end 122 and is sleeved on an exterior of the first actuating end 122, an outer wall of the motion-transmission member 26 passes through the rotation portion of the first connecting member 21 and is connected to an inner wall of the rotation portion in a position-limiting manner; wherein, under the action of the first drive motor 12, the first actuating end 122 drives the motion-transmission member 26 to rotate, and the motion-transmission member 26 drives the first connecting member 21 to rotate, so as to drive each of the plate members to move towards a neighboring plate member.

In one embodiment, each of the plate members extends along a first direction; there are a plurality of first connecting members 21, wherein the plurality of first connecting members 21 are spaced apart from one another along the first direction, the motion-transmission member 26 is mounted at the rotation portion of one of the first connecting members 21, wherein each of the remaining first connecting members 21 has a rotation portion rotatably connected to the first frame 11 and constitutes the limiting member.

Specifically, in this embodiment, the extending direction of the length of the plate member is the first direction, and a plurality of first connecting members 21 are distributed along the first direction, which can make the plate members move more steadily.

With this structure of the clamping mechanism, by providing the plurality of first connecting members 21 spaced apart from one another along the first direction, mounting the motion-transmission member 26 connected to the first actuating end 122 at the rotation portion of one of the first connecting members, and rotatably connecting the rotation portion of each of the remaining first connecting members 21 to the first frame 11, so that, during the rotation of one of the connecting members driven by the first actuating end 122, that is, during the change of spacing between each of the plate members and its neighboring plate member, due to that the plurality of first connecting members 21 are all connected to the plate members, the plate members can drive the remaining first connecting members 21 to rotate in unison, so that when the plurality of products are being simultaneously clamped, each product is clamped to a similar or even uniform degree, so that the ability of the clamping mechanism for clamping products is more reliable.

In one embodiment, the clamping mechanism further comprises a second drive assembly 3. The second drive assembly 3 comprises a second drive motor 31, a second frame 32 and a transmission structure 33, the second drive motor 31 is provided with a second fixed end 311 and a second actuating end 312, the second fixed end 311 is fixedly mounted on an external bracket, the second frame 32 is mounted upon the first frame 11, the transmission structure 33 comprises a rack 332 and a gear 331, the rack 332 is fixedly connected to the second frame 32, an extending direction of the rack 332 is parallel to a vertical direction, the gear 331 is connected to the second actuating end 312 in a motion-transmission manner, and the gear 331 is connected to the rack 332 in a motion-transmission manner.

With this structure of the clamping mechanism, by providing the second drive assembly 3, connecting the second actuating end of the second drive motor 31 to the gear 331 in a motion-transmission manner, and mounting the second frame 32 upon the first frame 11, at this time, if the second fixed end 311 of the second drive motor 31 is fixedly connected on an external bracket, due to that the extending direction of the rack 332 is parallel to a vertical direction, the gear 331 can drive the rack 332 to move along the vertical direction under the action of the second actuating end, and thus realizing that the second frame 32 fixedly connected to the rack 332 can move along the vertical direction, realizing that the first frame 11 connected to the second frame 32 can move along the vertical direction, and thus realizing that the plate members can move along the vertical direction, so that the clamping mechanism has the ability to move the clamped products along the vertical direction, which improves the experience of the user when using the clamping mechanism.

In one embodiment, the second drive assembly 3 further comprises a first connecting shaft 34, a second connecting shaft 36, a mounting base 41 and a seated bearing 37, one end of the first connecting shaft 34 is connected to the second actuating end 312 by means of a first coupling 351 in a motion-transmission manner; one end of the second connecting shaft 36 is connected to the other end of the first connecting shaft 34 by means of a second coupling 352 in a motion-transmission manner, the other end of the second connecting shaft 36 is connected to the gear 331 in a motion-transmission manner; the mounting base 41 is mounted on the second frame 32; the seated bearing 37 comprises a bearing seat 371 and a bearing inner ring 372, the bearing seat 371 is mounted on the mounting base 41, and the bearing inner ring 372 is sleeved on the second connecting shaft 36.

In one embodiment, the second drive assembly 3 further comprises a sliding block 38 and a sliding rail 39, the sliding block 38 is mounted on the mounting base 41, the sliding rail 39 is mounted on the second frame 32, the sliding rail 39 is movably connected to the sliding block 38, the sliding rail 39 is oriented in the vertical direction.

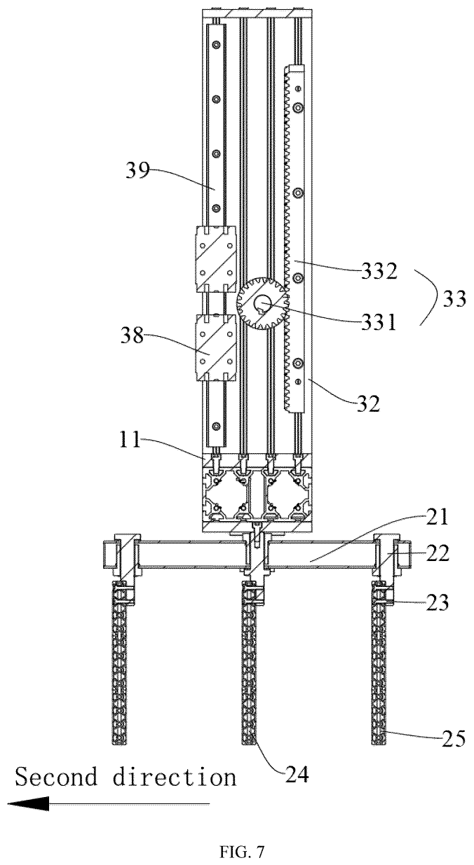

Specifically, in this embodiment, as shown in FIG. 7, the rack 332 is oriented vertically, wherein the gear 331 is susceptible to the influence of gravity when it moves, which would make the pressure exerted on the meshing portions relatively high when the gear 331 and the rack 332 are moved relative to each other, and in order to alleviate the pressure exerted on the meshing portions of the gear 331 and the rack 332, a damper is provided. Specifically, during installation, the damper is installed between the sliding block 38 and the sliding rail 39, so as to alleviate the pressure exerted on the meshing portions, thereby reducing the use requirement of the gear 331 and the rack 332, i.e., it is possible to select a smaller size for both the gear 331 and the rack 332, so as to miniaturize the volume of the entire second drive assembly 3, and thereby miniaturize the volume of the entire clamping mechanism.

With this structure of the clamping mechanism, by providing the sliding block 38 and the sliding rail 39, it is realized that the sliding block 38 can be moved along the guiding direction of the slide rail 39 after the sliding block 38 is mounted on the mounting base 41, which can reduce the resistance encountered by the clamping mechanism when it is moved along the vertical direction.

In one embodiment, if the length of the plate member is large, it can be provided with two second actuating ends 312; at this time, there are two second actuating ends 312; there may be two first connecting shafts 34 arranged in one-to-one correspondence with the two second actuating ends 312; there may be two second connecting shafts 36 arranged in one-to-one correspondence with the two second actuating ends 312; there may be two mounting bases 41 arranged in one-to-one correspondence with the two second actuating ends 312; there may be two seated bearings 37 arranged in one-to-one correspondence with the two second actuating ends 312; and there may be two transmission structures 33 arranged in one-to-one correspondence with the two second actuating ends 312.

Specifically, two second drive motors 31 with two second actuating ends 312 arranged in opposite directions are adopted, so that the two first connecting shafts 34, the two second connecting shafts 36, the two mounting bases 41, the two seated bearings 37, and the two transmission structures 33 can be symmetrically arranged on two lateral sides of the second fixed end 311, so that the plate members can be moved along the vertical direction more steadily.

In a second aspect, the present invention also provides a clamping apparatus comprising the clamping mechanism as described above. Since the clamping apparatus adopts the clamping mechanism of the above embodiments, it has the same beneficial effects as those of the clamping mechanism, which will not be repeated herein.

Although the embodiments of the present invention are described in combination with the accompanying drawings, those skilled in the art may make various modifications and variations without departing from the spirit and scope of the present invention, and such modifications and variations fall within the scope defined by the appended claims.

1. A clamping mechanism, comprising:
a first drive assembly (1), comprising a first frame (11) and a first drive motor (12), the first drive motor (12) being provided with a first fixed end (121) and a first actuating end (122), the first fixed end (121) being mounted on the first frame (11), and the first actuating end (122) being rotatable in a horizontal plane;
a clamping assembly (2), comprising a first connecting member (21) and a plurality of plate members, the first connecting member (21) being connected to the first actuating end (122) in a motion-transmission manner, the plurality of plate members being all connected to the first connecting member (21), each of the plate members being mounted underneath the first connecting member (21) along a height direction, and the plurality of plate members being spaced apart from one another;
wherein a limiting member is also provided between every two adjacent plate members, the limiting member is spaced apart from the first connecting member (21) and is configured to rotate in unison with the first connecting member (21), and under the action of the first drive motor (12), the first actuating end (122) drives the first connecting member (21) to rotate, so as to drive each of the plate members to move towards or away from a neighboring plate member by means of translational movement.

2. The clamping mechanism according to claim 1, wherein
the clamping assembly (2) further comprises a second connecting member (22) and a fastener (23), wherein the second connecting member (22) passes through the first connecting member (21) and is rotatably connected to the first connecting member (21);
each plate member is connected to the second connecting member (22) by means of the fastener (23).

3. The clamping mechanism according to claim 2, wherein
the plate members include a first plate member (24) and a second plate member (25), the first plate member (24) being movably connected to the first actuating end (122), wherein, there are two second plate members (25), the two second plate members (25) are respectively arranged on two lateral sides of the first plate member (24) along a horizontal direction and are respectively located at two ends of the first connecting member (21).

4. The clamping mechanism according to any one of claims 1-3, wherein
the first connecting member (21) is provided with a rotation portion;
the clamping assembly (2) further comprises a motion-transmission member (26), an inner wall of the motion-transmission member (26) is form-fitted to the first actuating end (122) and is sleeved on an exterior of the first actuating end (122), an outer wall of the motion-transmission member (26) passes through the rotation portion of the first connecting member (21) and is connected to an inner wall of the rotation portion in a position-limiting manner;
wherein, under the action of the first drive motor (12), the first actuating end (122) drives the motion-transmission member (26) to rotate, and the motion-transmission member (26) drives the first connecting member (21) to rotate, so as to drive each of the plate members to move towards a neighboring plate member.

5. The clamping mechanism according to claim 4, wherein
each of the plate members extends along a first direction;
there are a plurality of first connecting members (21), the plurality of first connecting members (21) being spaced apart from one another along the first direction, the motion-transmission member (26) being mounted at the rotation portion of one of the first connecting members (21), wherein each of the remaining first connecting members (21) has a rotation portion rotatably connected to the first frame (11) and constitutes the limiting member.

6. The clamping mechanism according to any one of claims 1-3, wherein the clamping mechanism further comprises:
a second drive assembly (3), comprising a second drive motor (31), a second frame (32) and a transmission structure (33), the second drive motor (31) being provided with a second fixed end (311) and a second actuating end (312), the second fixed end (311) being fixedly mounted on an external bracket, the second frame (32) being mounted upon the first frame (11), the transmission structure (33) comprising a rack (332) and a gear (331), the rack (332) being fixedly connected to the second frame (32), the gear (331) being connected to the second actuating end (312) in a motion-transmission manner, and the gear (331) being connected to the rack (332) in a motion-transmission manner, wherein an extending direction of the rack (332) is parallel to a vertical direction.

7. The clamping mechanism according to claim 6, wherein the second drive assembly (3) further comprises:
a first connecting shaft (34), one end of the first connecting shaft (34) being connected to the second actuating end (312) by means of a first coupling (351) in a motion-transmission manner;
a second connecting shaft (36), one end of the second connecting shaft (36) being connected to the other end of the first connecting shaft (34) by means of a second coupling (352) in a motion-transmission manner, the other end of the second connecting shaft (36) being connected to the gear (331) in a motion-transmission manner;
a mounting base (41), being mounted on the second frame (32);
a seated bearing (37), comprising a bearing seat (371) and a bearing inner ring (372), the bearing seat (371) being mounted on the mounting base (41), and the bearing inner ring (372) being sleeved on the second connecting shaft (36).

8. The clamping mechanism according to claim 7, wherein
the second drive assembly (3) further comprises a sliding block (38) and a sliding rail (39), the sliding block (38) being mounted on the mounting base (41), the sliding rail (39) being mounted on the second frame (32), the sliding rail (39) being movably connected to the sliding block (38), the sliding rail (39) being oriented in the vertical direction.

9. The clamping mechanism according to claim 8, wherein
there are two second actuating ends (312);
the first connecting shaft (34) is arranged in one-to-one correspondence with the two second actuating ends (312);
the second connecting shaft (36) is arranged in one-to-one correspondence with the two second actuating ends (312);
the mounting base (41) is arranged in one-to-one correspondence with the two second actuating ends (312);
the seated bearing (37) is arranged in one-to-one correspondence with the two second actuating ends (312);
the transmission structure (33) is arranged in one-to-one correspondence with the two second actuating ends (312).

10. A clamping apparatus, comprising the clamping mechanism according to any one of claims 1-9.
